(19) United States
(12) Patent Application Publication
(10) Pub. No.: US 2017/0262157 A1
(43) Pub. Date: Sep. 14, 2017

(54) DELETING A SYSTEM RESOURCE

(71) Applicant: MOTOROLA SOLUTIONS, INC., Schaumburg, IL (US)

(72) Inventors: Jacob Shem Tov, Jerusalem (IL); Shahar Kuchuk, Petah Tiqwa (IL)

(21) Appl. No.: 15/067,989

(22) Filed: Mar. 11, 2016

(51) Int. Cl. G06F 3/0484; G06F 9/50; G06F 3/0482; G06F 3/0481; G06F 3/0486

(52) U.S. Cl. CPC G06F 3/04842; G06F 3/04817; G06F 3/0486; G06F 3/0482; G06F 9/5005

(57) ABSTRACT

A method and device for deleting a system resource. The method includes receiving, by an electronic processor and via a graphical user interface, a delete command indicative of a selection of the system resource to be deleted, and initiating, by the electronic processor, a delete timer in response to the received delete command. The method also includes, with the electronic processor and based on the delete timer, modifying an icon representative of the selected system resource while displaying the icon, and completing, by the electronic processor, a deletion operation of the selected system resource when the delete timer reaches a predetermined duration.

### BACKGROUND OF THE INVENTION

Computing devices store and display various system resources. These resources may include, for example, programs (for example, mobile applications, word processing applications, media player applications, and the like), files (for example, text and video files), icons (for example, that provide access to programs and files), or data. The computing device typically displays some or all of the system resources in a graphical user interface (GUI). In some circumstances, it is desirable to delete a system resource using an input mechanism provided, for example, in the graphical user interface. However, in some cases a system resource may be accidentally deleted and, in some instances, it is not possible to recover the deleted resource.

Some computing devices provide a method of confirming that the system resource is to be deleted. For example, many computing devices generate an additional window (for example, a “pop-up” window) that requires a user to confirm that deletion of the system resource is desired. In such examples, the system resource is not deleted until the computing device receives an input confirming the deletion. This additional input step can be burdensome and time consuming to the user.

Some computing devices provide a “trash” can, folder, or similar location, where deleted system resources are placed before permanent deletion.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an exemplary computing device.

FIG. 2 is a flowchart of one exemplary method of a deletion operation of a system resource.

FIG. 3 is a flowchart another exemplary method of the deletion operation of the system resource.

FIGS. 4A through 4F illustrate changes to an exemplary graphical user interface during the deletion operation of an exemplary system resource when an abort command is received.

FIGS. 5A through 5E illustrate changes to an exemplary graphical user interface during a second deletion operation of an exemplary system resource with a value of a delete timer displayed.

FIG. 6 is an exemplary graphical user interface including a configuration window for the deletion operation of FIGS. 2 and 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides a method of deleting a system resource of a device. In one instance, the method includes receiving, by an electronic processor and via a graphical user interface a delete command indicative of a selection of the system resource to be deleted, and initiating, by the electronic processor, a delete timer in response to the received delete command. The method also includes, with the electronic processor and based on the delete timer, modifying an icon representative of the selected system resource while displaying the icon, and completing, by the electronic processor, a deletion operation of the selected system resource when the delete timer reached a predetermined duration.

Another exemplary embodiment provides a device including a display and an electronic processor electrically coupled to the display. The display is configured to display a graphical user interface. In one instance, the electronic processor is configured to receive, through the graphical user interface, a delete command indicative of a selection of a system resource to be deleted, and initiate a delete timer in response to the received delete command. The electronic processor is also configured to modify an icon representative of the selected system resource while displaying the icon and based on the delete timer, and complete a deletion operation of the selected system resource when the delete timer reaches a predetermined duration.

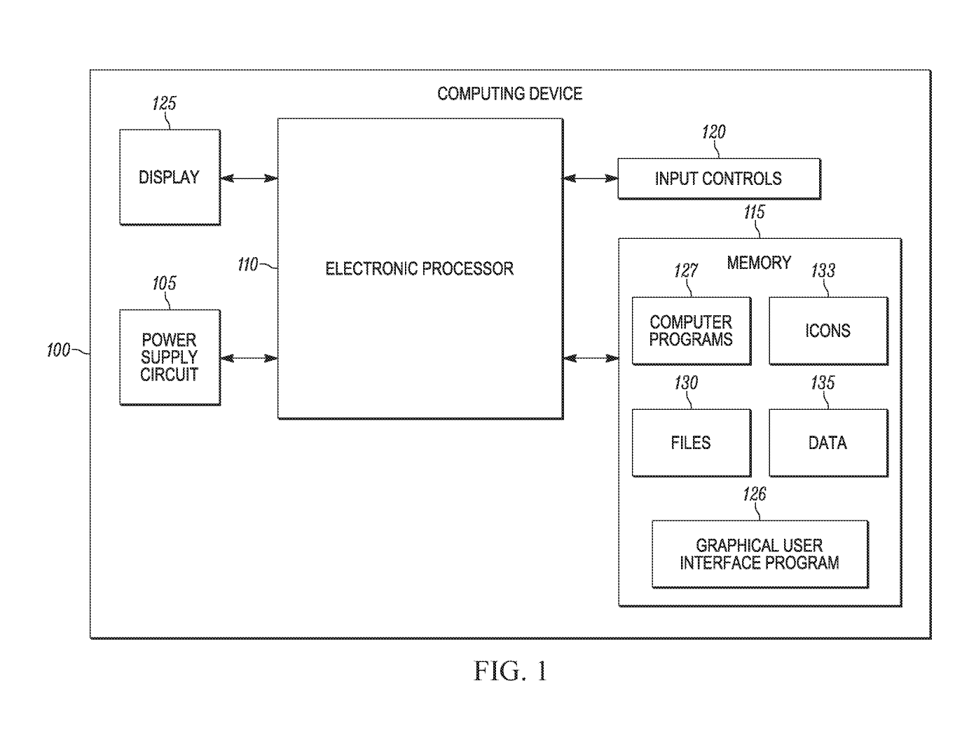

FIG. 1 is a block diagram of a computing device 100 according to one exemplary embodiment. In the illustrated example, the computing device 100 includes a power supply circuit 105, an electronic processor 110 (e.g., a microprocessor or another suitable programmable device), a memory 115 (e.g., a computer-readable medium), input controls 120, and a display 125. In the illustrated embodiment, the computing device 100 is a mobile communication device such as, for example, a mobile two-way radio used for example, to access applications related to public safety. However, in alternative embodiments, the computing device 100 may be a cellular telephone, a smart telephone, a mobile radio, a smart watch, a tablet computer, a personal digital assistant (PDA), or other electronic device that displays and deletes system resources. The term “system resource(s)” is used throughout this specification to refer to hardware and/or software, or combinations thereof, that are controlled by the operating system or a particular program of a computing device. These resources may include, for example, programs (for example, mobile applications, word processing applications, media player applications, and the like), files (for example, text and video files), icons (for example, that provide access to programs and files), or data.

The electronic processor 110, the memory 115, the input controls 120, the display 125, and the power supply circuit 105, as well as other various modules and components, are coupled to each other by or through one or more control or data buses, which enable communication therebetween. The use of control and data buses for the interconnection between and exchange of information among the various modules and components would be apparent to a person skilled in the art in view of the description provided herein. The electronic processor 110 controls the other components of the computing device 100. The electronic processor 110 obtains and provides information (for example, from the memory 115 and/or the input controls 120), and processes the information by executing one or more software instructions or modules, capable of being stored, for example, in a random access memory (“RAM”) area of the memory 115 (for example, during execution) or a read only memory (“ROM”) of the memory 115 (for example, on a generally permanent basis) or another non-transitory computer readable medium. The software can include firmware, one or more applications, program data, filters, rules, one or more program modules, and other executable instructions. The electronic processor 110 retrieves from the memory 115 and executes, among other things, software related to the control processes and methods described herein.

The power supply circuit 105 receives power (for example, from a removable battery) and distributes the electrical power to the other components of the computing device 100. Although not shown in FIG. 1, the power supply circuit 105 may have direct connections to the other components (for example, display 125, input controls 120, and the memory 115). The power supply circuit 105 may include additional electrical components such as, for example, a step-down controller, circuit protection circuitry, battery management circuit, and the like, to condition and manage the power received from an external source (for example, battery or outlet) to the power requirements of the other components of the computing device 100.

The input controls 120 receive input from, for example, a user of the computing device 100. The input controls 120 obtain information and signals from devices both internal and external to the computing device 100. The input controls 120 are illustrated schematically, but may include various physical buttons (e.g., a keypad), knobs, dials, actuators, a microphone, a scroll ball, and the like, configured to receive selections and/or commands from a user. The input controls 120 may extend through a housing of the computing device 100 to allow access by a user. The input controls 120 are electrically coupled to the electronic processor 110 to send the selections and/or commands received from the user to the electronic processor 110. For example, one of the input controls 120 may include a cursor-control device coupled to the electronic processor 110 that allows a user to select system resources and/or icons thereof displayed on the display 125.

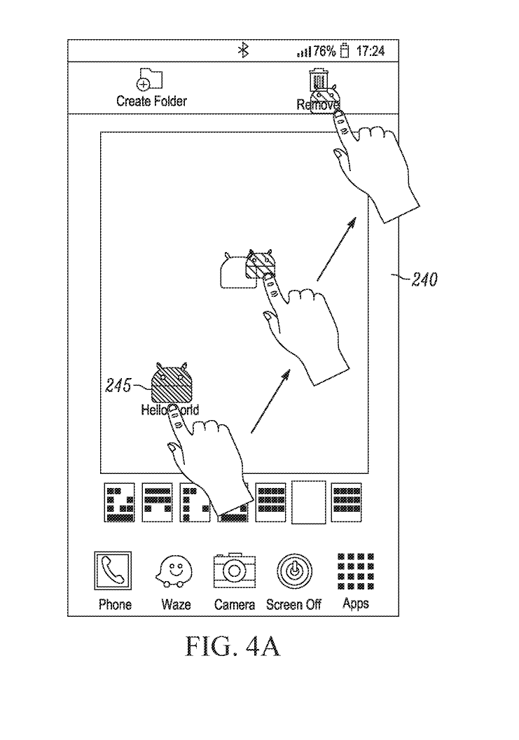

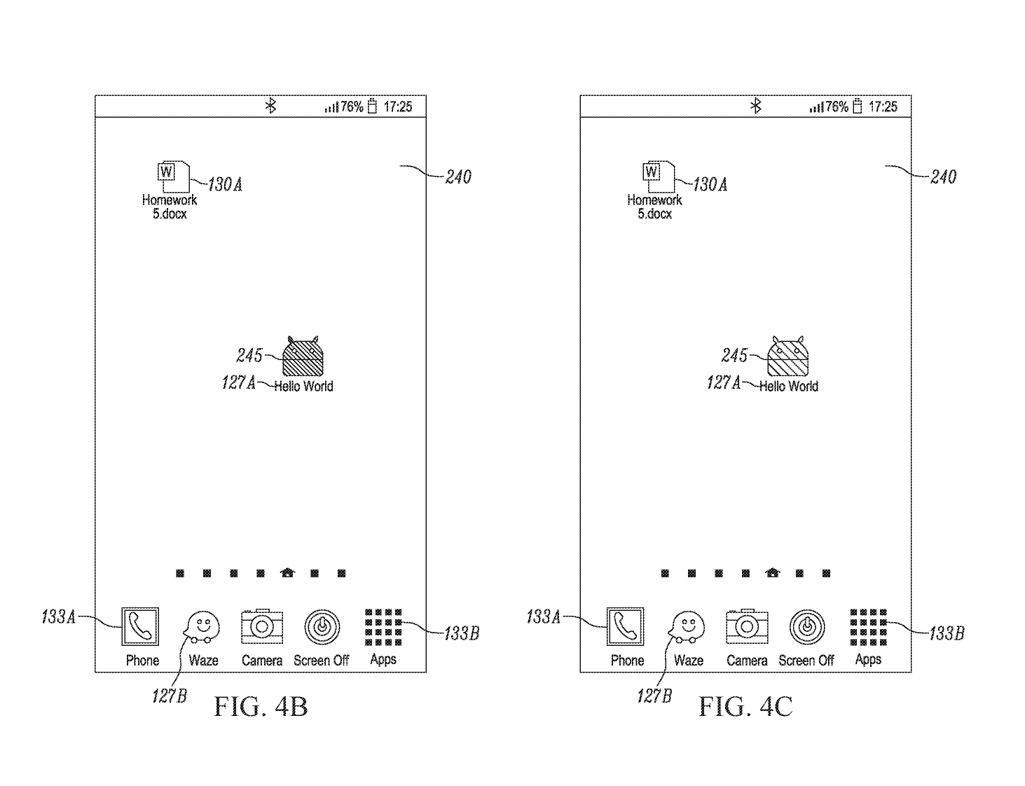

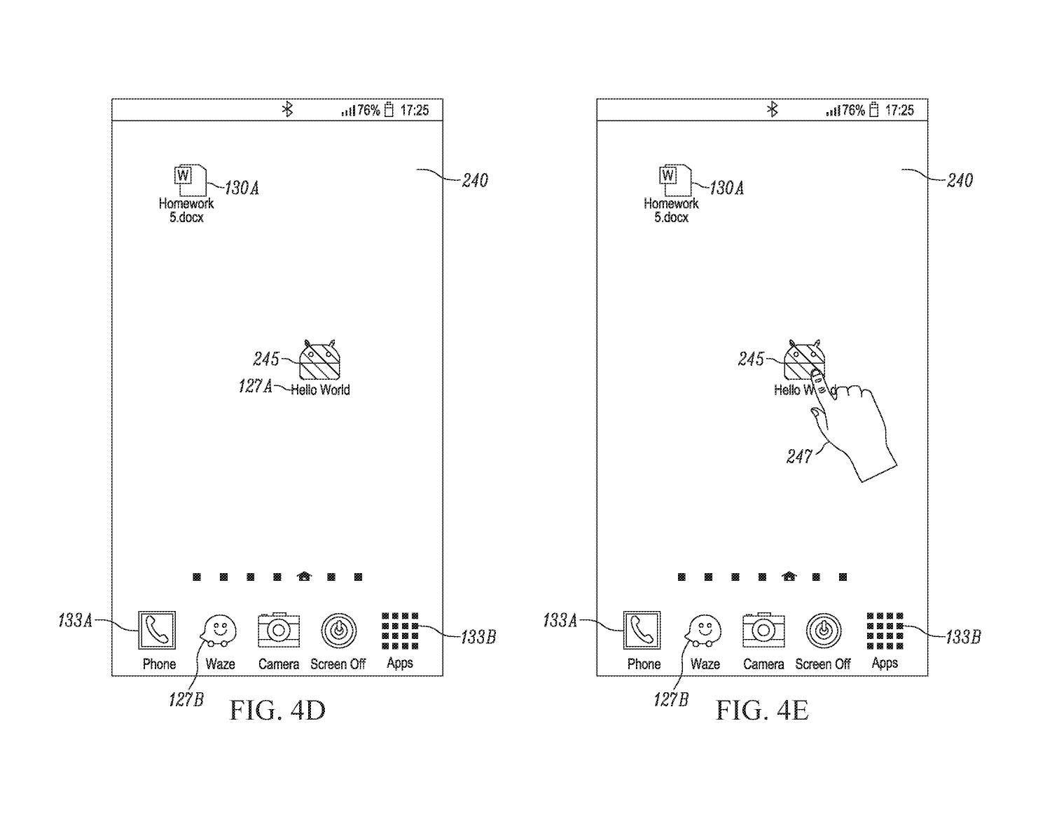

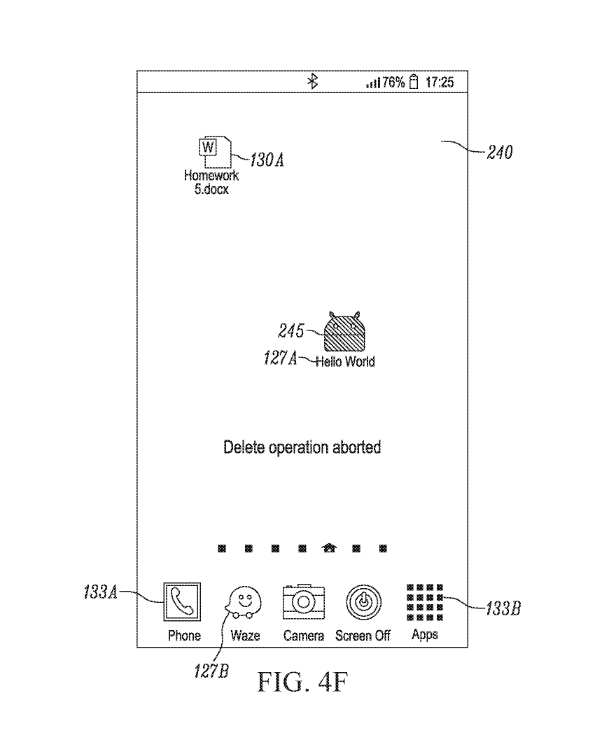

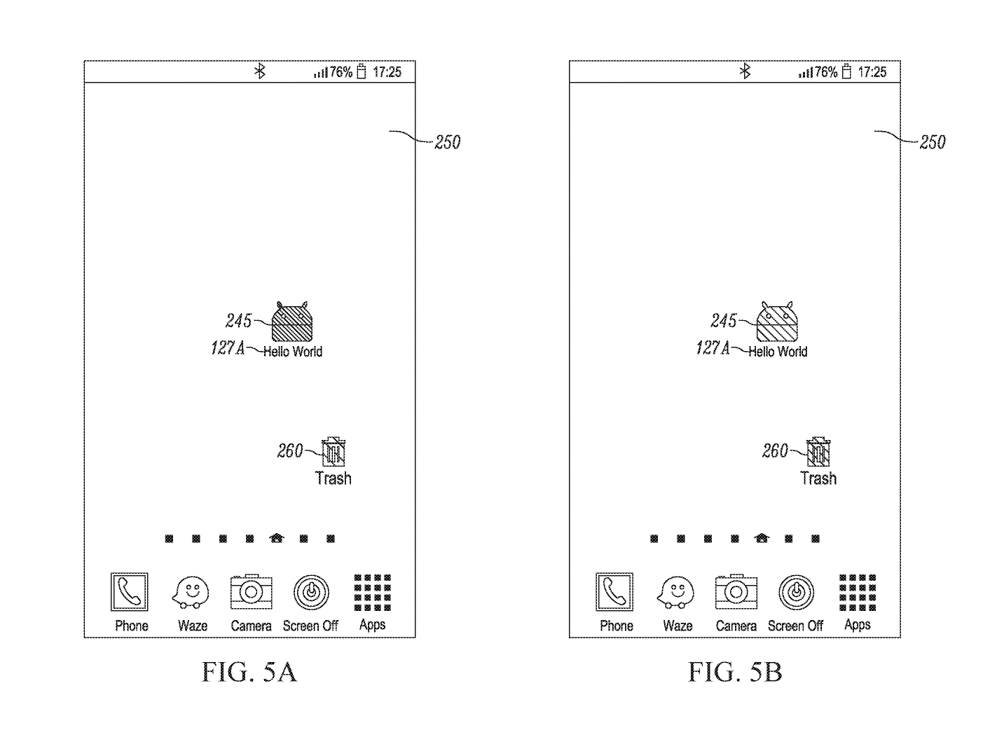

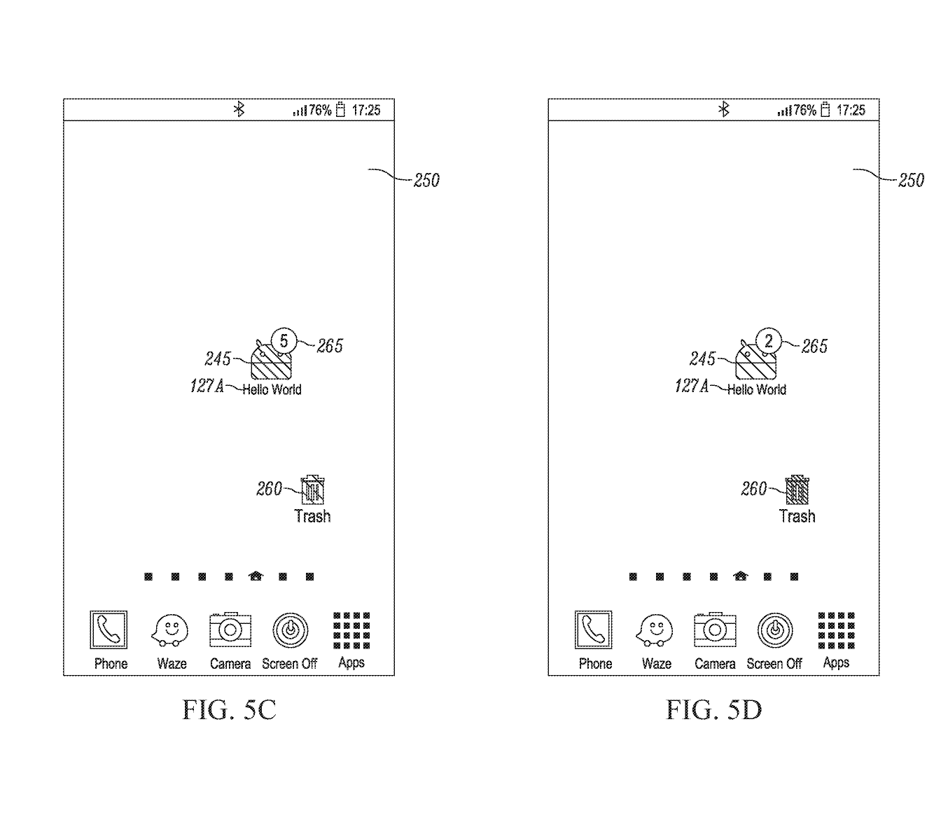

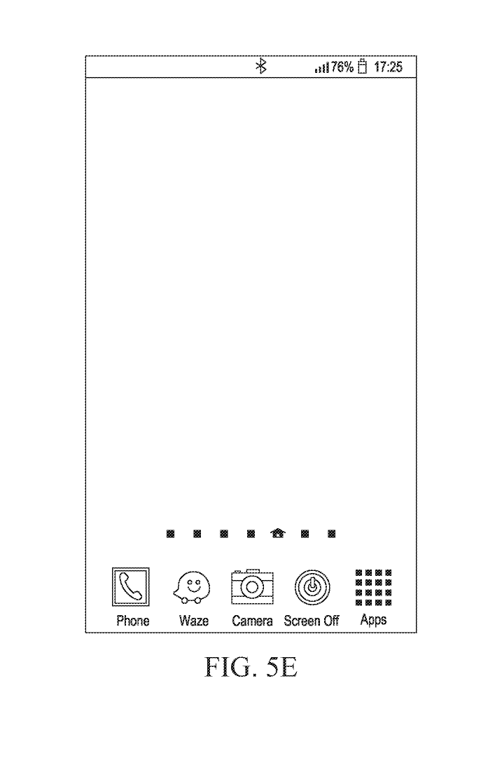

In addition to physical controls, the computing device 100 may include virtual or “soft” controls. For example, the electronic processor 110 may generate a graphical user interface 240 (FIGS. 4A through 4F) or 250 (FIGS. 5A through 5E), that is displayed on the display 125 and generated with a graphical user interface program 126 stored on the memory 115. The graphical user interface 240 (FIGS. 4A through 4F) or 250 (FIGS. 5A through 5E) enables a user to interact with the computing device 100, and may include various elements such as soft keys, icons, or soft buttons that are selectable using a cursor-control device, for example, a mouse (not shown). In other embodiments, the computing device 100 is a mobile communication device that includes a touchscreen. The touchscreen includes a display device that allows a user to interact with a computer by touching areas on the display device. When the computing device 100 includes a touchscreen, virtual buttons, “soft keys” and the like may be displayed on the touchscreen and selected via contact with the touchscreen with, for example, a stylus or a finger. The touchscreen may be, for example, a capacitive touchscreen, a resistive touchscreen, and the like.

The display 125 is a suitable display device such as, for example, a liquid crystal display (LCD), or an organic light-emitting diode (OLED) touch screen. The display 125 is electrically coupled to the electronic processor 110 and displays the graphical user interface 240 (FIGS. 4A through 4F) or 250 (FIGS. 5A through 5E) generated by the electronic processor 110. As shown in FIGS. 4A through 6, the graphical user interface displays various system resources and/or icons thereof and allows the user to interact (for example, access, move, delete, and the like) with the system resources and their respective icons. The computing device 100 may also include various output devices such as, for example, indicator lights, a speaker, a buzzer, and/or a vibratory element to provide visual, auditory, and haptic feedback to the user.

The memory 115 is electrically coupled to the electronic processor 110 and stores various system resources to be accessed by the electronic processor 110. The memory 115 can include one or more non-transitory computer readable media, and includes a program storage area and a data storage area. The program storage area and the data storage area can include combinations of different types of memory, as described herein. For example, the memory 115 may include, for example, a hard disk, a CD-ROM (Compact Disc Read-Only Memory), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. The memory 115 stores system resources including, for example, as shown in FIG. 1, computer programs 127 (for example, an operating system, applications (for example, word processing, image management, a messaging program, computer games, and the like)) to be executed by the electronic processor 110. In particular, the memory 115 stores a graphical user interface program 126 accessed by the electronic processor 110 to generate the graphical user interface for the computing device 100. The memory 115 may also include files 130 (for example, word documents, pictures, text messages, presentations, media files, and the like), icons 133 representative of different system resources, and data 135 (for example, contact lists, passwords, internet history, usernames, healthcare data, personally identifiable data, and the like). In some embodiments, the memory 115 may be divided into one or more portions or modules, each portion storing information for different applications or programs, different types of information, and/or having different retaining time periods.

As discussed above, the electronic processor 110 receives selections and/or commands through the input controls 120 (or the touchscreen if one is used), and retrieves and executes corresponding methods and/or instructions from the memory 115. For example, the electronic processor 110 is configured to receive a delete command with respect to a selected system resource. The delete command indicates that the selected system resource is to be deleted from the computing device 100.

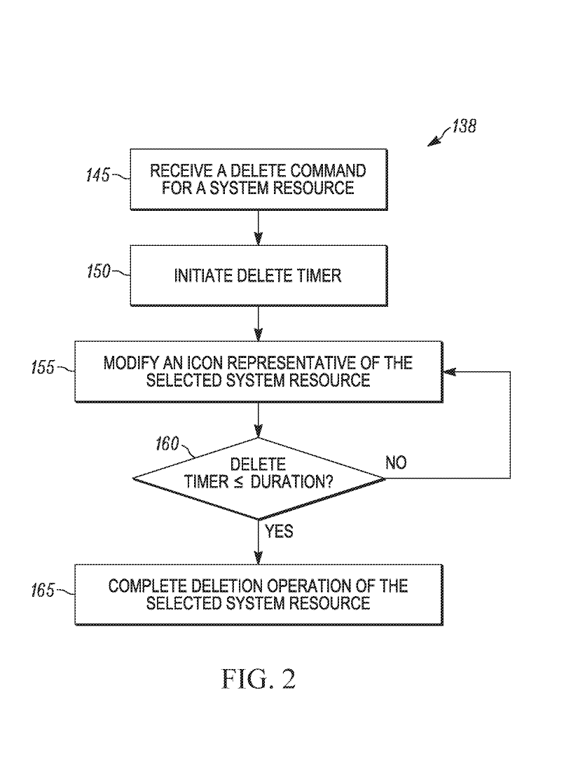

Referring to FIG. 2, to facilitate the deletion of a system resource, the electronic processor 110 implements a method 138 of deleting a system resource that provides an opportunity to cancel the deletion of the system resource without occupying additional display space or block other system resources. As shown in greater detail in FIG. 2, in one example, the electronic processor 110 receives a delete command for a system resource (block 145). Then, the electronic processor 110 initiates a delete timer (block 150). The delete timer has a predetermined duration and delays a deletion operation of the selected system resource by the predetermined duration. In some exemplary embodiments, the predetermined duration is the same for all system resources. In other embodiments, the predetermined duration is different based on, for example, the type of system resource being deleted. In some embodiments, the delete timer may increment its value with time, such that when the predetermined duration has elapsed the value of the delete timer is equal to or greater than the predetermined duration. In other embodiments, the delete timer may decrement its value with time, such that when the predetermined duration has elapsed, the value of the delete timer is zero. In the remainder of this description, methods and systems are described where the delete timer is a decrementing timer. It is to be understood that these methods and systems could be implemented, with appropriate modifications, with an incrementing delete timer. The electronic processor 110 delays a deletion operation of the selected system resource by waiting for a duration of the delete timer to elapse. Such a delay enables a user to cancel the deletion operation of the selected system resource to inhibit accidental deletion of the selected system resource. The electronic processor 110 then modifies an icon representative of the system resource to be deleted based on the delete timer (block 155). The icon representative of the system resource is described herein as being a visual representation of the system resource, and may include an image representative of the system resource, a name representative of the system resource, or any other visual representation of the system resource. In alternative embodiments, however, the system resource may be represented with an auditory representation, a haptic representation, and the like. The electronic processor 110 modifies the representation of the system resource regardless of whether the representation is a visual representation, an auditory representation, or a haptic representation.

The electronic processor 110 gradually modifies the icon representative of the system resource, or an alternate representation of the system resource by the computing device 100, to provide a visual alert to a user that the selected system resource is to be deleted without occupying additional display space. The electronic processor 110 determines whether the current value of the delete timer is less than or equal to a specific duration (block 160). When the current value of the delete timer is not less than or equal to the specific duration, the electronic processor 110 continues to modify the icon representative of the selected system resource (block 155). Finally, when a specific duration of the delete timer has elapsed, the electronic processor 110 completes the deletion operation of the selected system resource (block 165). By implementing the method 138, the electronic processor 110 provides an indication that the selected system resource is to be deleted without occupying additional display space. When the electronic processor 110 receives an abort command indicating that the system resource is not to be deleted, before the predetermined time has elapsed, the deletion operation is cancelled. The abort command is any input that terminates a previously requested operation (that is, deletion of a selected system resource) and tries to return the computing device 100 to a state that existed before the operation (that is, deletion of the selected system resource) was requested. In one exemplary embodiment, the abort command includes an input received during the duration of the delete timer, and may include, for example, a re-selection of the system resource, a selection or re-selection of the destination (e.g., a trash folder) of the system resource, and the like. Monitoring for a received abort command during the deletion operation provides a user with an opportunity to cancel the deletion operation, if necessary or desired. On the other hand, when no abort command is received before the expiration of the delete timer, deletion of the system resource occurs without additional user input and without further occupying display space and/or resources. In other words, expiration of the delete timer provides the electronic processor 110 with confirmation that the delete operation is to be completed. By modifying the icon representative of the system resource to be deleted, the computing device 100 facilitates efficient management of system resources.

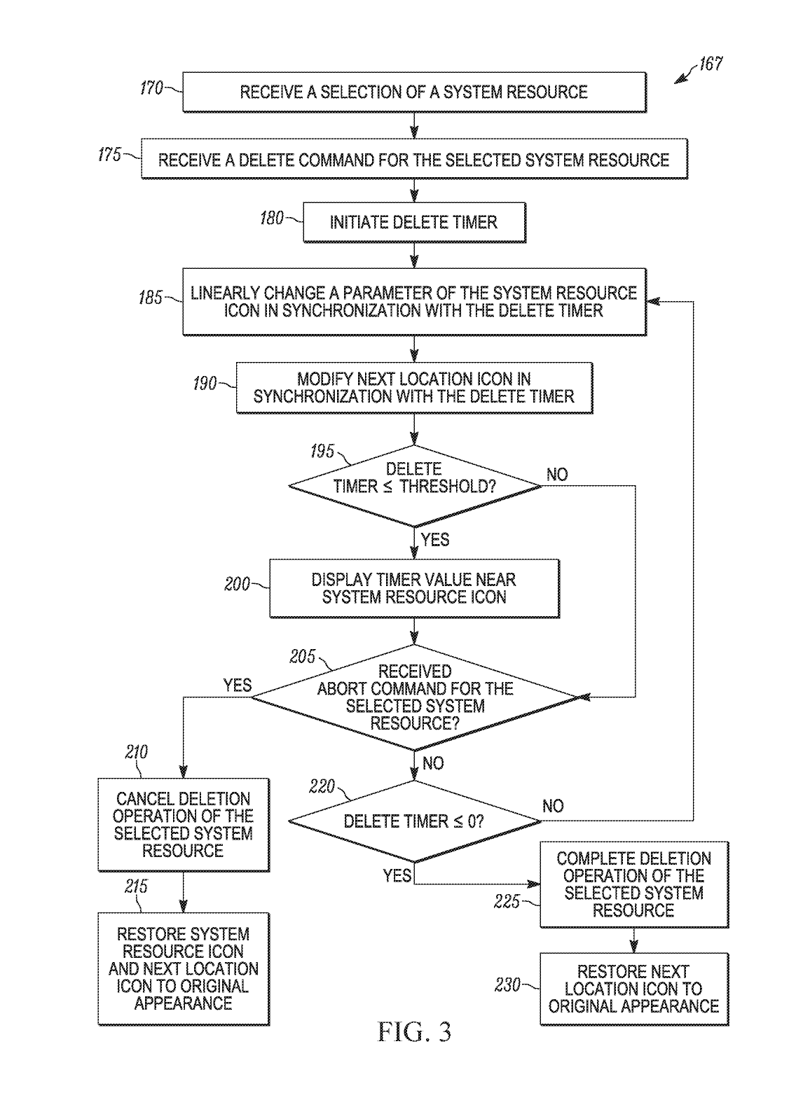

FIG. 3 illustrates a method 167, which is more detailed version of the method 138. In the example provided by method 167, the electronic processor 110 first receives a selection of a system resource (block 170). As mentioned above, the system resource may include one of the computer programs 127, files 130, icons 133, or data 135 stored in the memory 115 of the computing device 100. The electronic processor 110 may receive the selection via, for example, a cursor-control device or a touchscreen. The electronic processor 110 then receives a delete command for the selected system resource (block 175). As shown in FIG. 4A, the delete command may be received by dragging a selected system resource to a trash icon, thereby indicating that the selected system resource is to be deleted. In other embodiments, the delete command may be received by receiving a selection of a delete function from a drop-down menu associated with the selected system resource. In response to receiving the delete command, the electronic processor 110 initiates a delete timer (block 180).

In the example of FIG. 3, the electronic processor 110 also linearly changes a characteristic of the system resource icon in synchronization with the delete timer (block 185). The system resource icon refers to the icon representative of the selected system resource. By linearly changing a characteristic of the system resource icon, the electronic processor 110 gradually modifies the system resource icon. For example, in some embodiments, the electronic processor 110 fades the system resource icon in synchronization with the delete timer such that as the value of the delete timer decreases, the system resource icon becomes less visible (for example, linearly increases the transparency of the system resource icon in synchronization with the delete timer). In other embodiments, the electronic processor 110 changes a color of the resource icon in synchronization with the delete timer. Other characteristics associated with the system resource icon may be gradually changed to generate a visual change of the system resource icon. In other embodiments, the characteristic of the system resource icon is changed in a non-linear manner. Regardless of whether the change is linear, non-linear, continuous, abrupt, or otherwise, by modifying the system resource icon, the computing device 100 generates a visual alert to the user that the selected system resource will be deleted soon (for example, in the next few seconds).

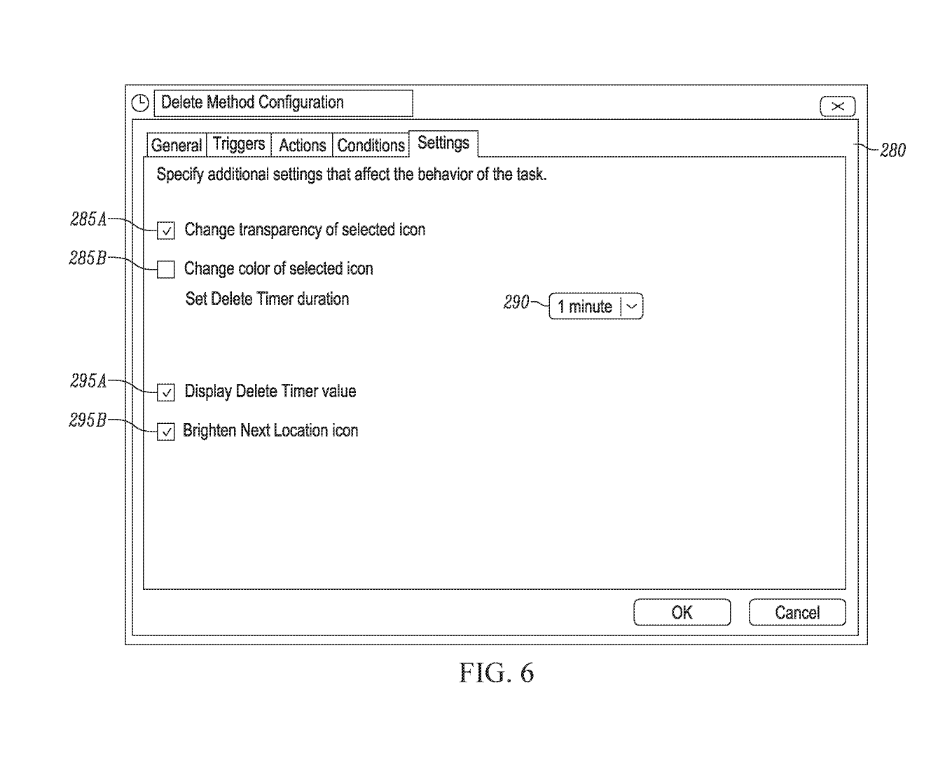

In the embodiment illustrated, in addition to modifying the system resource icon, the electronic processor 110 also modifies a next location icon in synchronization with the delete timer (block 190). The next location icon is representative of the future location of the selected system resource once the selected system resource has been deleted. In one embodiment, the next location may be a trash can, folder, or similar location. In such an embodiment, the next location icon includes an icon representative of the trash location. As described above with respect to the system resource icon, the electronic processor 110 may modify the next location icon in a variety of ways. For example, the electronic processor 110 may linearly or non-linearly change a characteristic (for example, a color or brightness) associated with the next location icon in synchronization with the delete timer, or the like. The characteristics changed by the electronic processor 110 may be stored in the graphical user interface program 126 stored in the memory 115. It is to be understood that, in some embodiments, the electronic processor 110 does not modify the next location icon. Modification of the next location item may, in some embodiments be configurable by the user as shown in FIG. 6. In other embodiments, however, the modification of the next location item is not configurable by the user (e.g., the user cannot determine whether to modify the next location item or not).

While modifying the system resource icon and the next location icon, the electronic processor 110 periodically determines whether the value of the delete timer is less than or equal to a threshold (block 195). When the electronic processor 110 determines that the value of the delete timer is greater than the predetermined duration, the electronic processor 110 proceeds to determine whether an abort command has been received (block 205). When, on the other hand, the electronic processor 110 determines that the value of the delete timer is less than or equal to (for example, does not exceed) the threshold, the electronic processor 110 begins to display the current value of the delete timer near the system resource icon (block 200). By comparing the value of the delete timer with the threshold, the electronic processor 110 only displays the current value of the delete timer near the system resource icon for a portion of the duration of the delete timer (for example, during the last nine seconds). The electronic processor 110 may display the current value of the delete timer adjacent the system resource icon as the system resource icon continues to be modified by the electronic processor 110 in synchronization with the delete timer. In other embodiments, the electronic processor 110 may display the current value of the delete timer overlaid on the system resource icon as the system resource icon is modified in synchronization with the delete timer. In yet other embodiments, the electronic processor 110 may display the current value of the delete timer for the entire duration of the delete timer. For such embodiments, block 195 becomes unnecessary since the current value for the delete timer is displayed during the entire duration of the delete timer. In other embodiments, the value of the delete timer is not displayed at all. In such embodiments, the functions of blocks 195 and 200 are unnecessary and the electronic processor 110 does not perform them.

The electronic processor 110, after starting to display the value of the delete timer near the system resource icon at block 200, determines whether an abort command for the selected system resource has been received (block 205). The abort command may be received from a cursor-control device (for example, a mouse) or a touchscreen of the computing device 100. In the example illustrated in FIG. 4E, the abort command includes a first input from a touchscreen indicating a re-selection of the selected system resource. Such a re-selection indicates to the electronic processor 110 that the deletion operation of the selected system resource is to be cancelled. When the electronic processor 110 determines, at block 205, that an abort command was received, the electronic processor 110 cancels the deletion operation of the selected system resource (block 210), and restores the system resource icon and, if applicable, the next location icon to their original appearances at block 215 (for example, before the electronic processor 110 modifies the system resource icon and the next location icon). Otherwise, when the electronic processor 110 determines that no abort command has been received for the selected system resource, the electronic processor 110 determines whether the value of the delete timer is less than or equal to zero (that is, whether the predetermined duration of the delete timer has elapsed) at block 220.

When the electronic processor 110 determines that the value of the delete timer has not yet reached zero, the electronic processor 110 returns to block 185 to continue modifying the system resource icon and the next location icon, and displaying the value of the timer. When, on the other hand, the electronic processor 110 determines that the value of the delete timer has reached zero, the electronic processor 110 completes the deletion operation of the selected system resource (block 225). The electronic processor 110 also restores the next location icon to its original appearance (block 230). The implementation of the delete timer and the modification of the system resource icon and the next location icon provide a cancellable action for the user that does not require additional resources (for example, display space) and that inhibits accidental deletions of selected system resources.

In the embodiments described above, the modification of the system resource icon begins immediately after the timer has been initiated. However, in other embodiments, the modification of the system resource icon begins only when the value of the delete timer is below a predetermined threshold (for example, a threshold similar to the one referenced in block 195). In such embodiments, after the electronic processor 110 initiates the delete timer, the electronic processor 110 performs a check, similar to the check of block 195, to determine whether the value of the delete timer is below or equal to a predetermined threshold. The electronic processor 110 only begins modifying the system resource icon and the next location icon when the value of the delete timer drops below or is equal to the predetermined threshold.

FIGS. 4A through 4F illustrate a graphical user interface (GUI) 240 generated by the electronic processor 110. In particular, FIGS. 4A through 4F illustrate changes of an icon 245 representative of a selected system resource and cancellation of the deletion operation of a selected system resource in response to the electronic processor 110 receiving an abort command while the electronic processor 110 implements the system resource deletion method 167 discussed above with respect to FIG. 3. In FIGS. 4A through 4F, relative opacity and/or transparency of the icon 245 is generally illustrated by different levels of hatching of the icon 245. For example, less hatching represents less opacity and higher transparency of the icon 245, while more hatching represents higher opacity and lower transparency of icon 245. FIGS. 4A through 4F, however, do not illustrate modification of a next location icon or the display of the timer value as described with respect to blocks 190 through 200 of FIG. 3.

As shown in FIGS. 4A through 4F, the graphical user interface 240 includes a plurality of system resources including a first computer program 127a, a second computer program 127b, a file 130a, and a plurality of icons 133a and 133b. In the embodiment illustrated by FIGS. 4A through 4F, the selected system resource refers to the first computer program 127a that includes an icon 245 (similar to the system resource icon referred to in FIG. 3). FIG. 4A illustrates an indication of a delete function by dragging the first computer program 127a into a trash location. Upon detection of the delete function from a user, the electronic processor 110 receives the delete command as discussed with respect to block 175 of FIG. 3. FIGS. 4B through 4D illustrate the gradual modification of the icon 245. Although the timer value corresponding to each of FIGS. 4B through 4D is not shown, it is to be understood that FIG. 4B illustrates the graphical user interface 240 and the icon 245 generated upon initiation of the delete timer, FIG. 4C illustrates the graphical user interface 240 and the icon 245 generated when the delete timer is approximately 50 percent of its original value, and FIG. 4D illustrates the graphical user interface 240 and the icon 245 generated when the delete timer is approximately 25 percent of its original value. In the embodiments illustrated by FIGS. 4A through 4F, the electronic processor 110 linearly increases the transparency of the icon 245 in synchronization with the delete timer as discussed with respect to block 185 of FIG. 3. Therefore, the icon 245 of FIG. 4B is more heavily hatched than the icon of FIG. 4C, which is more heavily hatched than the icon of FIG. 4D.

FIG. 4E illustrates a re-selection 247 via the graphical user interface 240 of the first computer program 127a. The re-selection 247 of the first computer program 127a (or the icon 245) after the delete timer has been initiated, but before the predetermined duration of the delete timer has elapsed, sends an abort command to the electronic processor 110. In other words, re-selection of the selected system resource after the delete timer is initiated and before the delete timer has elapsed is interpreted as an abort command. When the electronic processor 110 receives the abort command with respect to the first computer program 127a, the electronic processor 110, as discussed above with respect to blocks 210 and 215 of FIG. 3, cancels the deletion operation of the first computer program 127a. The electronic processor 110 also restores the icon 245 to its original appearance (for example, the transparency of the icon 245 as illustrated by the level of hatching of the icon 245 returns to its original setting), as shown in FIG. 4F.

FIGS. 5A through 5E illustrate a second graphical user interface 250 generated by the electronic processor 110. In particular, FIGS. 5A through 5E illustrate changes in the second graphical user interface 250 that occur as the electronic processor 110 implements the system resource deletion method 138 discussed above with respect to FIG. 3. Unlike FIGS. 4A through 4F, however, FIGS. 5A through 5E illustrate a modification of a next location icon and the display of a timer value as described with respect to blocks 190 through 200 of FIG. 3. FIGS. 5A through 5E also illustrate the completion of the deletion operation of the selected system resource in response to the predetermined duration of the timer elapsing. As described above, relative opacity and/or transparency of icons (for example, a selected system icon and a next location icon) is generally illustrated by different levels of hatching of the icon. For example, less hatching represents less opacity and higher transparency of the icon, while more hatching represents higher opacity and lower transparency of the icon.

As shown in FIGS. 5A through 5E, the second graphical user interface 250 includes the icon 245 representing the first computer program 127a and a second icon 260 representing a trash location. In the embodiment illustrated by FIGS. 5A through 5E, the selected system resource refers again to the first computer program 127a, the system resource icon refers to the icon 245, and the next location icon refers to the second icon 260. FIGS. 5A through 5D illustrate the gradual fading (represented by changing hatching levels) of the icon 245 (for example, similar to the fading of the icon 245 shown in FIGS. 4A through 4D), and the gradual increase in brightness (represented by changing hatching levels) of the second icon 260, both in synchronization with the delete timer. FIG. 5A illustrates the second graphical user interface 250 including the icon 245 and the second icon 260 upon initiation of the delete timer (for example, immediately after receiving the delete command with respect to the first computer program 127a). In the embodiment illustrated in FIGS. 5A through 5E, the delete timer has a duration of 20 seconds. FIG. 5B illustrates the icon 245 and the second icon 260 generated when the delete timer is approximately 50 percent of its original value, for example, the delete timer value is approximately 10 seconds. In the embodiment illustrated in FIGS. 5A through 5E, the threshold for the electronic processor 110 to display the value of the delete timer is approximately 25 percent of the delete timer's original value, which for this example corresponds to approximately five seconds. Therefore, since FIG. 5B illustrates the second graphical user interface 250 when the delete timer still has approximately 50 percent of its duration left (that is, 10 seconds), the value of the delete timer is not displayed in FIG. 5B.

FIG. 5C illustrates the second graphical user interface 250 generated when the delete timer is approximately 25 percent of its original value (that is, the delete timer value is approximately five seconds). Since the delete timer is approximately 25 percent of its original value, the electronic processor 110 determines that the current value of the delete timer (for example, five seconds) is less than or equal to the threshold, which in this example corresponds to five seconds, and the electronic processor 110 begins to display the value 265 of the delete timer at least partially overlaid on the icon 245. As shown in the example of FIG. 5C, the electronic processor 110 displays the number five, which corresponds to the value 265 of the delete timer. When the electronic processor 110 receives an abort command before the delete time elapses, the electronic processor 110 cancels the deletion operation. Otherwise, the deletion operation of the first computer program 127a is completed. It should be understood that in different embodiments, the duration of the delete timer is different and/or the threshold used to determine when to display the value of the delete timer is different.

FIG. 5D illustrates the second graphical user interface 250 generated when the delete timer is approximately 10 percent of its original value (that is, for this example, two seconds). The electronic processor 110 again displays the value 265 of the delete timer overlaid on the icon 245. As shown in FIG. 5D, the electronic processor 110 displays the number five, which corresponds to the value 265 of the delete timer. Unless the electronic processor 110 receives an abort command in the following two seconds, the deletion operation of the first computer program 127a is completed. FIG. 5E illustrates the second graphical user interface 250 generated when the duration of the delete timer has elapsed. As shown in FIG. 5E when the duration of the delete timer elapses without the electronic processor 110 receiving an abort command, the deletion operation of the first computer program 127a is completed and the second icon 260 representative of the trash location, where the first computer program 127a is located after the deletion operation, is restored to its original settings (that is, its original brightness settings).

The electronic processor 110 may change the duration of the delete timer based on, for example, the type of system resource selected to be deleted, the size of the system resource being deleted, or an input received by the electronic processor 110 from the user, as shown in FIG. 6. FIG. 6 illustrates a configuration window 280 for settings regarding the deletion method described with respect to FIG. 3. As shown in FIG. 6, the electronic processor 110 may receive indications of various aspects of the deletion operation and method described herein. For example, first checkbox 285a and second checkbox 285b may indicate whether the electronic processor 110 is to change the transparency of the system resource icon, change the color of the system resource icon, or both. As shown in FIG. 6, the configuration window 280 also includes a drop-down menu 290 for selecting a duration for the delete timer. In the illustrated embodiment, the duration for the delete timer has been set to one minute. The configuration window 280 further includes a third checkboxes 295a and a fourth checkbox 295b to indicate whether the delete timer value is to be displayed near the system resource icon, and whether the electronic processor 110 is configured to modify the next location icon, respectively. Accordingly, the various characteristics for the delete method as described, in particular, with respect to FIG. 3, may be modified based on user inputs received by the electronic processor 110.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of deleting a system resource of a device, the method comprising:
receiving, by an electronic processor and via a graphical user interface, a delete command indicative of a selection of the system resource to be deleted;
initiating, by the electronic processor, a delete timer in response to the received delete command;
with the electronic processor and based on the delete timer, modifying an icon representative of the selected system resource while displaying the icon; and
completing, by the electronic processor, a deletion operation of the selected system resource when the delete timer reaches a predetermined duration.

2. The method of claim 1, further comprising displaying, via the graphical user interface, a current value of the delete timer adjacent to the icon representative of the selected system resource.

3. The method of claim 1, further comprising displaying, via the graphical user interface, a current value of the delete timer overlaid on the icon representative of the selected system resource.

4. The method of claim 1, further comprising displaying, via the graphical user interface, a current value of the delete timer for a portion of the predetermined duration.

5. The method of claim 1, wherein modifying the icon representative of the selected system resource includes modifying, by the electronic processor, the icon representative of the selected system resource in synchronization with the delete timer.

6. The method of claim 5, wherein modifying, by the electronic processor, the icon includes fading the icon representative of the selected system resource in synchronization with the delete timer.

7. The method of claim 5, wherein modifying the icon includes changing, with the electronic processor, a color of the icon representative of the selected system resource in synchronization with the delete timer.

8. The method of claim 5, wherein modifying the icon includes linearly changing, with the electronic processor, a characteristic of the icon representative of the selected system resource in synchronization with the delete timer.

9. The method of claim 1, further comprising:
receiving, with the electronic processor, an abort command through the graphical user interface before the delete timer reaches the predetermined duration; and
canceling, with the electronic processor, the deletion operation of the selected system resource in response to the received abort command.

10. The method of claim 1, further comprising:
receiving, with the electronic processor, a user input through the graphical user interface; and
changing, with the electronic processor, the predetermined duration based on the user input.

11. The method of claim 1, wherein the system resource includes one of a group consisting of a file, an icon, a program, and data.

12. A device comprising
a display configured to display a graphical user interface;
an electronic processor electrically coupled to the display, the electronic processor configured to
receive, through the graphical user interface, a delete command indicative of a selection of a system resource to be deleted,
initiate a delete timer in response to the received delete command,
modify an icon representative of the selected system resource while displaying the icon and based on the delete timer, and
complete a deletion operation of the selected system resource when the delete timer reaches a predetermined duration.

13. The device of claim 12, wherein the electronic processor is further configured to display a current value of the delete timer adjacent to the icon representative of the selected system resource.

14. The device of claim 12, wherein the electronic processor is further configured to display a current value of the delete timer overlaid on the icon representative of the selected system resource.

15. The device of claim 12, wherein the electronic processor is further configured to display a current value of the delete timer for a portion of the predetermined duration.

16. The device of claim 12, wherein the electronic processor is configured to modify the icon by fading the icon representative of the selected system resource in synchronization with the delete timer.

17. The device of claim 12, wherein the electronic processor is configured to modify the icon by linearly changing a characteristic of the icon representative of the selected system resource in synchronization with the delete timer.

18. The device of claim 12, wherein the electronic processor is further configured to:
receive an abort command through the graphical user interface before the delete timer reaches the predetermined duration; and
cancel the deletion operation of the selected system resource in response to receiving the abort command.

19. The device of claim 12, wherein the electronic processor is further configured to:
receive a user input through the graphical user interface; and
change the predetermined duration based on the user input.

20. The device of claim 12, wherein the system resource includes one of a group consisting of a file, an icon, a program, and data.
